(19) United States
(12) Patent Application Publication
(10) Pub. No.: US 2007/0014901 A1
(43) Pub. Date: Jan. 18, 2007

(54) Method for applying carbon monoxide to meat products

(75) Inventor: Eldon Roth, Dakota Dunes, SD (US)

Correspondence Address: THE CULBERTSON GROUP, P.C., 1114 LOST CREEK BLVD., SUITE 420, AUSTIN, TX, 78746, US

(73) Assignee: Freezing Machines, Inc.

(21) Appl. No.: 11/510,357

(22) Filed: Aug. 25, 2006

Related U.S. Application Data
(63) Continuation-in-part of application No. 11/502,841, filed on Aug. 11, 2006.
Application No. 11/502,841 is a continuation of application No. 10/795,000, filed on Mar. 5, 2004, now Pat. No. 7,094,435.
(60) Provisional application No. 60/736,631, filed on Nov. 15, 2005.

(51) Int. Cl. A23L 1/27

(52) U.S. Cl. 426/263

(57) ABSTRACT

Carbon monoxide and an ammonia-based pH increasing material are both applied to a highly comminuted meat product. The carbon monoxide and ammonia-based pH increasing material may be applied by sparging the materials into the highly comminuted meat product through a suitable sparging device. The carbon monoxide may be applied to the highly comminuted meat product separately from the ammonia-based pH increasing material, or the two materials may be combined and applied to the highly comminuted meat product together. When applied separately, the carbon monoxide and ammonia-based pH increasing materials may be applied to the meat product through a multi-stage sparging device. Also, when the treatment materials are applied separately either material may be applied first followed by application of the other material.

### CROSS-REFERENCE TO RELATED APPLICATION

This application is a continuation-in-part of U.S. patent application Ser. No. 11/502,841, filed Aug. 11, 2006, and entitled “Method for Treating Meat Products With Carbon Monoxide,” which is a continuation of U.S. patent application Ser. No. 10/795,000, filed Mar. 5, 2004, and originally entitled “Method and Apparatus for Treating Meat Products With Carbon Monoxide.” The benefit of these prior applications is hereby claimed in the present application pursuant to 35 U.S.C. §120. This application also claims the benefit under 35 U.S.C. §119(e) of U.S. Provisional Patent Application Ser. No. 60/736,631, filed Nov. 15, 2005, and entitled “Method and Apparatus for Treating Meat Products With a Treatment Liquid Containing Carbon Monoxide.” The entire content of each of these prior applications is incorporated herein by this reference.

### TECHNICAL FIELD OF THE INVENTION

This invention relates to meat processing operations. More particularly, the invention relates to methods for treating highly comminuted meat products with carbon monoxide.

### BACKGROUND OF THE INVENTION

It has long been known that carbon monoxide may be used to produce a bright red color in a meat product. U.S. Pat. No. 4,522,835 to Woodruff et al. discloses a process of treating meat products with carbon monoxide gas to modify the color at the surface of the meat product.

It has also been proposed to use carbon monoxide gas as a preservative in meat products. U.S. Pat. No. 6,270,829 to Shaklai discloses a process where raw meat is exposed to carbon monoxide gas for a sufficient period to saturate the meat with carbon monoxide to inhibit microbial activity in the meat product. The Shaklai patent also discloses that the carbon monoxide saturation in the meat product produces a color change throughout the meat product.

Carbon monoxide gas has also been used in an injection material to treat meat products. U.S. Pat. No. 3,119,696 to Williams discloses injecting meat with a water and gas combination for the purpose of improving the tenderness of the meat. The Williams patent discloses that the gas is included in the water/gas treatment material to help facilitate absorption of the water fraction into the meat. The Williams patent also discloses that carbon monoxide may be included in the gas portion of the water/gas combination in order to modify the color of the meat in the interior of the meat product.

The change in color from carbon monoxide treatment results from the reaction of carbon monoxide with hemoglobin and myoglobin in meat products to form carboxyhemoglobin and carboxymyoglobin respectively. The microbial activity inhibiting effect of carbon monoxide in meat products is at least in part produced by reducing the oxygen content in the meat product. This reduction in oxygen content creates an unsuitable environment for aerobic microbes. Carbon monoxide treatment may also inhibit the growth and propagation of anaerobic microbes as well.

Despite the benefits, there remain certain problems associated with treating meat products with carbon monoxide. One problem with treating uncooked meats with carbon monoxide is that the treatment may affect the color of the product after the meat begins to spoil and after cooking. In particular, prior art carbon monoxide treatments may produce a bright red color that persists in the uncooked meat even after the meat begins to spoil due to microbial activity in the meat. Thus, prior art carbon monoxide treatments may mask spoilage in a meat product. Also, prior art carbon monoxide treatments may leave the uncooked meat with a bright red color that remains in the meat even after the meat is cooked. This unnatural red color in the cooked meat product occurs throughout the product where the entire product is saturated with carbon monoxide. Even where only the surface of the meat product is saturated with carbon monoxide, the surface of the cooked meat product may have an unnatural red color and the meat may not brown properly. Thus, although the carbon monoxide treated, uncooked meat product may have an appearance that is desirable to consumers, the color in the uncooked meat product may mask spoilage and the color remaining in the cooked meat product may be unacceptable to consumers.

### SUMMARY OF THE INVENTION

The present invention provides a method for treating meat products with carbon monoxide to obtain the benefits associated with carbon monoxide treatment while reducing or eliminating the problems associated with unnatural color in the uncooked and cooked meat product. It is noted that the term “meat product” is used here and throughout this disclosure and the accompanying claims to refer to meat alone, including lean portions, fat, and related materials of beef, pork, poultry, or seafood, and to refer to meat that has been mixed with, or includes, additives such as flavorings, extenders, tenderizing agents, and other materials. This invention is particularly applicable to highly comminuted meat products. As used in this disclosure and the accompanying claims, a “highly comminuted” meat product is a meat product that has been ground, chopped, or otherwise comminuted so that the meat product includes primarily pieces having a major dimension, of approximately one inch or less.

According to the invention, carbon monoxide and an ammonia-based pH increasing material are both applied to a highly comminuted meat product. As used in this disclosure and in the accompanying claims, an ammonia-based pH modifying material may be any material that, when added to a meat product, results in an ammonium hydroxide solution in the meat product. In some preferred forms of the invention, the carbon monoxide and ammonia-based pH increasing material are applied by sparging the materials into the highly comminuted meat product through a suitable sparging device. The carbon monoxide may be applied to the highly comminuted meat product separately from the ammonia-based pH increasing material, or the two materials may be combined and applied to the highly comminuted meat product together. One preferred form of the invention applies the carbon monoxide and ammonia-based pH increasing material separately to the highly comminuted meat product through a multi-stage sparging device. The invention encompasses applying either the carbon monoxide or the ammonia-based pH increasing material first, and the other material second.

Where carbon monoxide and the ammonia-based pH increasing material are applied separately, the carbon monoxide may be applied as a gas mixed with other gases, or may be carried in a suitable carrier liquid. Water is one preferred carrier liquid. The carbon monoxide may be held in solution in the water, or suspended as gas, or both. The ammonia-based pH increasing material applied separately from the carbon monoxide may be applied in the form of ammonia gas alone or mixed with other gases, or in the form of an ammonium hydroxide solution (ammonia in solution with water).

Where carbon monoxide and the ammonia-based pH increasing material are combined into a single treatment material and then applied to the highly comminuted meat product, the single treatment material may comprise water with both ammonia and carbon monoxide held in solution in the water. Either ammonia gas or carbon monoxide gas may additionally be held in suspension in the water. Alternatively to applying carbon monoxide and the ammonia-based pH increasing material combined with a carrier liquid, carbon monoxide in gaseous form and ammonia gas may be combined without any carrier liquid to produce a single treatment material for application to the highly comminuted meat product.

The amount of carbon monoxide applied to the highly comminuted meat product is preferably controlled to produce a desired carbon monoxide saturation level in the highly comminuted meat product. Applying carbon monoxide may be performed such that the resulting highly comminuted meat product includes a substantially uniform carbon monoxide concentration throughout the meat product. This substantially uniform carbon monoxide saturation may be produced by applying the carbon monoxide in a sparging device to a relatively narrow stream of the highly comminuted meat product. The stream of meat product may have a thickness approximately equal to a dimension of the pieces of meat making up the highly comminuted meat product. However, some forms of the invention may produce the desired uniform carbon monoxide concentration by further comminuting the highly comminuted meat product or mixing or otherwise agitating the highly comminuted meat product after or concurrently with the application of carbon monoxide.

The desired carbon monoxide saturation level may vary depending upon the nature of the meat being treated, however, the saturation level will generally remain at less than 100% (that is, less than complete saturation) for most meat products. As used in this disclosure and the accompanying claims, complete or 100% carbon monoxide saturation in a meat product refers to the case where all of the available hemoglobin and myoglobin in the meat product has been reacted with carbon monoxide to produce carboxyhemoglobin and carboxymyoglobin respectively. It will be noted that this does not necessarily mean that all hemoglobin and all myoglobin has been reacted since some hemoglobin and myoglobin in a meat product may reside in a state in which the reaction with carbon monoxide may not occur and may thus not be available to react with the carbon monoxide. Carbon monoxide saturation levels less than complete saturation may be described in this disclosure and the following claims as a percentage relative to complete saturation. For example, as used in this disclosure and the accompanying claims, 50% carbon monoxide saturation means that one-half of the available hemoglobin and myoglobin in the meat product has been converted to carboxyhemoglobin and carboxymyoglobin, respectively.

It believed that the carbon monoxide affects the manner in which pH modifying materials such as ammonia-based pH increasing materials are absorbed into the meat products. In particular, it is believed that the carboxy forms of hemoglobin and myoglobin formed from carbon monoxide treatment do not allow certain constituents in the pH modifying material to be absorbed with the hemoglobin and myoglobin. These constituents of the pH modifying material are beneficially absorbed elsewhere in the meat product. It is also believed that when pH modifying material is used together with carbon monoxide, the pH modifying material may help reduce the effect of the carbon monoxide on the color of the meat product and/or help make the color change less persistent. Thus, carbon monoxide treatments according to the present invention may produce the desired microbe inhibiting effect without unduly maintaining the red color in the treated product which might mask spoilage or adversely affect the appearance of the cooked product.

These and other advantages and features of the invention will be apparent from the following description of preferred embodiments, considered along with the accompanying drawings.

### BRIEF DESCRIPTION OF THE DRAWINGS

FIG. 1 is a block diagram illustrating the steps in one preferred treatment method embodying the principles of the present invention.

FIG. 2 is a diagrammatic representation of a system for applying carbon monoxide and an ammonia-based pH increasing material to a highly comminuted meat product according to one preferred form of the present invention.

FIG. 3 is a diagrammatic representation of an alternate system for applying carbon monoxide and an ammonia-based pH increasing material to a highly comminuted meat product according to the present invention.

### DESCRIPTION OF PREFERRED EMBODIMENTS

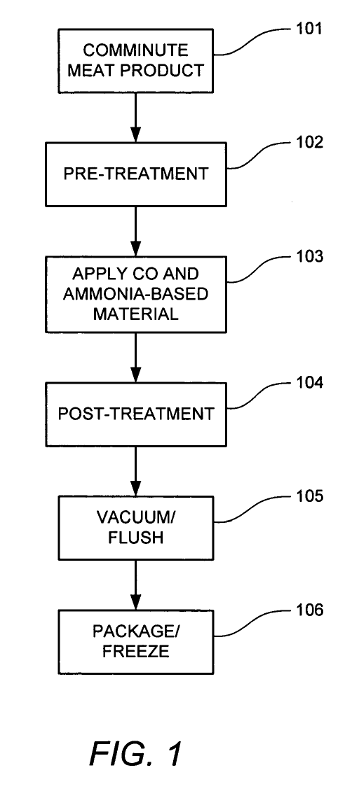

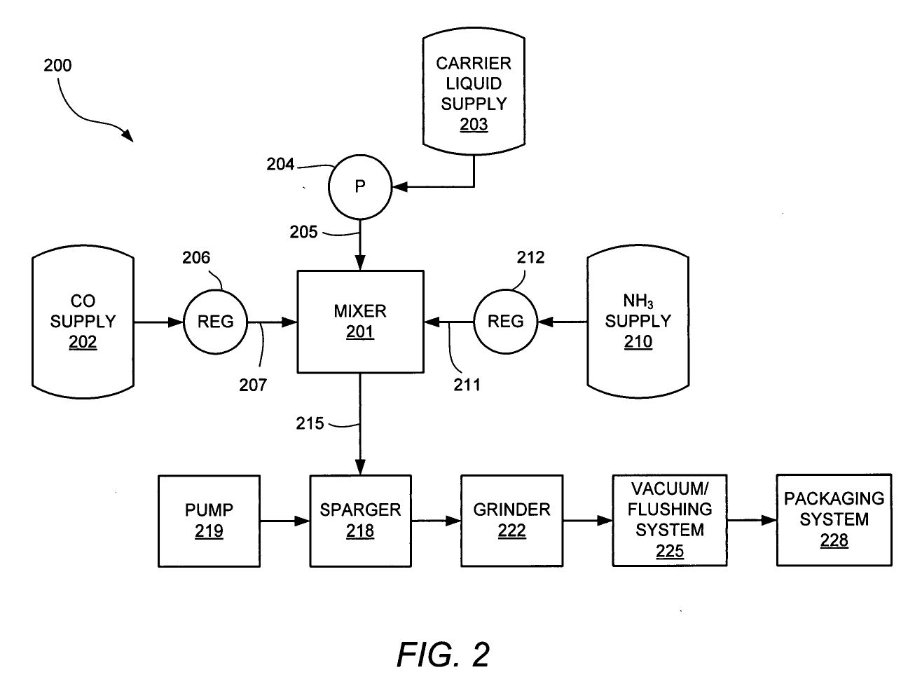

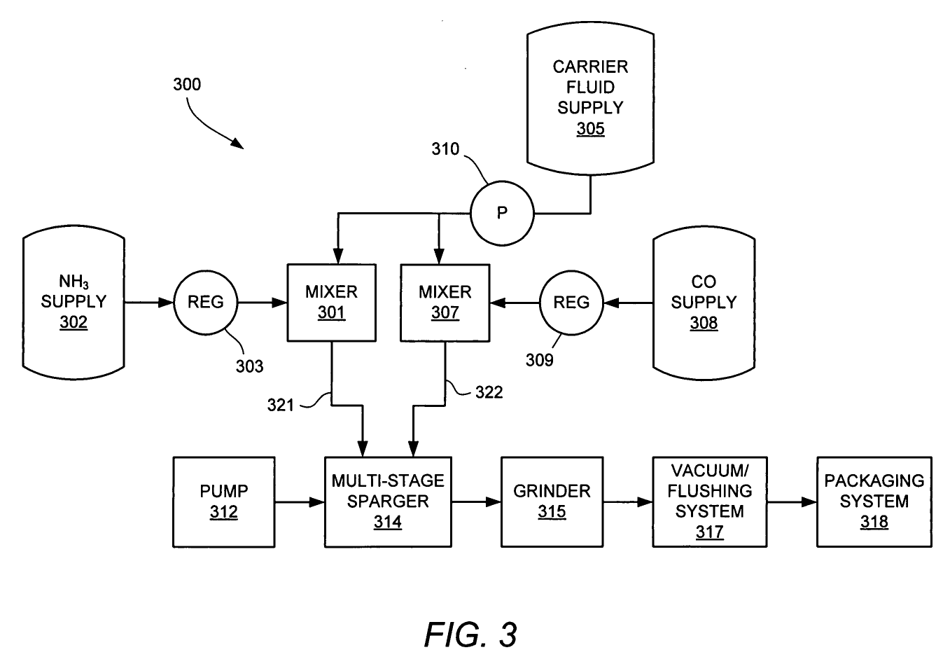

FIG. 1 will be used to describe various treatment methods within the scope of the invention. FIGS. 2 and 3 will be used to describe apparatus that may be used to treat meat products according to the invention and to describe further variations on the treatment methods shown in FIG. 1.

Referring to FIG. 1, a treatment process embodying the principles of the present invention may include first comminuting a meat product as indicated at process block 101 to produce a highly comminuted meat product. The process shown in FIG. 1 also includes a pre-treatment as indicated at process block 102 prior to the application of carbon monoxide and ammonia-based pH increasing material as shown at process block 103. FIG. 1 also shows a post-treatment at process block 104 after the application of carbon monoxide and ammonia-based pH increasing material. After the post-treatment, a vacuum/flushing operation is performed on the treated meat product as indicated at process block 105 and then the treated meat product is packaged or frozen and packaged as indicated at process block 106.

It should be noted that some of the process steps shown in FIG. 1 are merely optional steps and are not necessary to the present invention. Fundamentally, the present invention includes applying carbon monoxide and ammonia-based pH increasing material to a highly comminuted meat product as indicated at process block 103 in FIG. 1. Comminuting a meat product as shown at process block 101 to produce the highly comminuted meat product for carbon monoxide and ammonia-based pH increasing material treatment may or may not be included in a process according to the invention. Some applications of the present invention may rely on receiving previously comminuted meat products for application of carbon monoxide and pH increasing material, and may thus not include a comminuting step. Also, the pre-treatment and post-treatment shown at process blocks 102 and 104, respectively, may or may not be employed in a process according to the present invention. Likewise, the vacuum/flushing step shown at process block 105 and the packaging/freezing step shown at process block 106 may not be used in a given implementation of the invention. For example, it is possible for a highly comminuted meat product to be treated with carbon monoxide and ammonia-based pH increasing material as shown at process block 103 in FIG. 1, and then the resulting treated material immediately transferred to a bulk display case, fully or partially cooked, or incorporated into an end product.

Where a comminuting step is included as shown at process block 101 in FIG. 1, the required comminution may be performed in any suitable manner. For example, coarsely comminuted meat pieces may be comminuted through one or more grinder stages. Alternatively, coarsely comminuted meat pieces may be further comminuted in a bowl chopper. Any other comminuting process may be employed to comminute the meat product down to the desired one inch or smaller pieces as measured along the longest, that is, major dimension of the respective piece.

Pre-treatments and post-treatments as shown at process blocks 102 and 104 may include numerous different types of treatments within the scope of the present invention. For example, one preferred post-treatment includes applying a pH decreasing material such as carbon dioxide gas or weak carbonic acid solution to the meat product. A pH decreasing material may also be applied to the highly comminuted meat product as a pre-treatment. Other pre or post-treatments may include adding pure water or brines, adding flavorings, or adjusting the temperature of the highly comminuted meat product. One preferred form of the invention includes a further comminution step as a post-treatment.

The step of applying a vacuum or applying a flushing medium to the treated meat product as shown at process block 105 in FIG. 5 may be employed to remove excess carbon monoxide and/or ammonia-based pH increasing material and/or excess pre or post-treatment material from the treated meat product. For example, the treated meat product may be passed through a vacuum chamber or may be subjected to a stream of inert gas to remove excess treatment materials. The application of a vacuum or flushing gas may also be accompanied by an increase in temperature in the treated meat product to help release treatment materials from the meat.

Any suitable packaging or freezing and packaging may be employed as indicated at process block 106. For example, a highly comminuted meat product that has been treated with carbon monoxide and ammonia-based pH increasing material may be packaged in a traditional chub package. Alternatively, meat products that have been treated according to the invention may be packaged in any suitable modified atmosphere package. Where the product is frozen, it may first be formed into sheets, patties, or other suitable shapes and then frozen by a suitable freezing device. Alternatively, a meat product that has been treated according to the present invention may be frozen in the form of a sheet and then cut into chips which are then packaged in a suitable manner.

The carbon monoxide and ammonia-based pH increasing material may be applied in substantially any suitable manner at process block 103 in FIG. 1. Carbon monoxide may be applied separately from the ammonia-based pH increasing material or the two materials may be combined in some form and the combination then applied to the comminuted meat product. The arrangement described below in connection with FIG. 2 provides an example treatment system in which the carbon monoxide and ammonia-based pH increasing material are combined with a carrier liquid and the resulting combination is then applied to the highly comminuted meat product. The arrangement described below in connection with FIG. 3 provides an example treatment system in which carbon monoxide and ammonia-based pH increasing material are applied separately to the highly comminuted meat product. In any application process within the scope of the invention, the carbon monoxide may be at least partly in gaseous form, or may be entirely in solution in a suitable carrier liquid. Similarly, the ammonia-based pH increasing material may be ammonia gas or a gas mixture containing ammonia gas, or may be an ammonium hydroxide solution. In order to better control the effects of carbon monoxide application, some preferred forms of the invention apply carbon monoxide as a solute in solution with a carrier liquid such as water. Thus, the content of carbon monoxide in the carrier liquid may be at or below the solubility level of carbon monoxide in the carrier liquid at the temperature of the carrier liquid and at the application pressure, or some lower pressure to which the meat product will be subjected after application, such as atmospheric pressure for example. It should be noted that the presence of other materials dissolved in the carrier liquid may affect the amount of carbon monoxide that may be held in solution in the carrier liquid. Thus, the carbon monoxide content in the carrier liquid may vary depending upon the other materials to be held in solution in the carrier liquid.

Although some preferred forms of the invention utilize a carbon monoxide treatment material in which substantially all of the carbon monoxide is held in solution in a carrier liquid, some carbon monoxide in such a carbon monoxide treatment material may also be in the form of a gas suspended in the carrier liquid or as a gas atomizing/vaporizing the carrier liquid. Also, carbon monoxide may be applied as a gas. Whether the carbon monoxide is applied as a gas or in solution, or both in solution and in gas form, the carbon monoxide may be from any suitable source. For example, carbon monoxide may be supplied from a cylinder containing commercially produced pure carbon monoxide, or may be supplied from a food grade smoke generator. Regardless of the form or source of carbon monoxide applied to the highly comminuted meat product, the total carbon monoxide content in the carbon monoxide-bearing material applied as indicated at process block 103 in FIG. 1 should be low enough to avoid 100% carbon monoxide saturation in the treated meat product.

The desired carbon monoxide saturation level in the treated meat product may vary with the nature of the meat product being treated. In some meat products, such as those that have or will have added seasonings, carbon monoxide saturation may approach 100% saturation. In lightly seasoned or unseasoned meat products, such as plain ground beef for example, the desired carbon monoxide saturation according to the invention remains below 100% saturation, and preferably less than approximately 95%. Carbon monoxide saturation levels at approximately 70%, 60%, 50%, and 40% may also be used according to the invention. Again, depending upon the meat product being treated, the desired carbon monoxide saturation level may range from approximately 5% to 95% saturation. It should also be noted that the desired carbon monoxide saturation level in the treated meat product may vary with the amount of liquid added to the meat product. For example, a meat product treated according to the invention with added liquid content at 20% by weight with the meat may allow a higher desired carbon monoxide saturation level than at an added liquid content at 5% by weight with the meat. In any event, the carbon monoxide saturation level in the meat product treated according to the present invention should include a carbon monoxide saturation level or content low enough for the particular comminuted meat product to allow the meat product to brown properly in the course of cooking and to show visible signs of spoilage in the meat product when the product spoils due to bacterial activity.

The resulting pH in a comminuted meat product that has been treated with carbon monoxide and an ammonia-based pH increasing material according to the present invention may range from 5.6 to 8.0 or higher. Good results have been produced where the carbon monoxide/pH treated meat product had a final pH of 6.5 to 6.7 as well as where the treated product had a pH of 7.4. The pH of an ammonium hydroxide solution applied to the meat product may range from 8.5 to 11.6 or more. It should also be noted that the desired pH of an ammonium hydroxide solution comprising the ammonia-based pH increasing material applied at process block 103 in FIG. 1 may vary with the level of liquid added to the meat product in the present treatment process. For relatively low amounts of added liquid such as approximately 5% by weight with the meat, a pH of 11.6 or more in an ammonium hydroxide treatment material may be more appropriate. For higher added liquid content, say 15% to 20% for example, a pH of approximately 8.5 in an ammonium hydroxide treatment material may be more appropriate.

Where the ammonia-based pH increasing material comprises ammonium hydroxide solution and is applied separately before applying carbon monoxide, or where a pre-treatment application of water is employed in the process illustrated in FIG. 1, carbon monoxide may generally be added at a higher concentration than would otherwise be desirable. Also, it is generally desirable to apply carbon monoxide in gaseous form (either alone or mixed with other gasses) only after a liquid treatment material such as ammonium hydroxide, water, or brine has been applied to the comminuted meat. Where carbon monoxide is applied as a gas, the gases in a mixture with carbon monoxide may help the carbon monoxide to distribute better in the volume of the meat product. Although any suitable carbon monoxide concentration may be used, carbon monoxide concentration in preferred gaseous treatment material may be as low as one-tenth of a percent (0.1%).

Where carbon monoxide is applied in a gas mixture at process block 103 in FIG. 1, one preferred gas mixture includes oxygen in a suitable concentration. Oxygen may also be included with liquid treatment fluids in the form of suspended or dissolved oxygen gas or in the form of some other oxygenating material. Oxygen gas, dissolved oxygen, and any oxygenating material may each be referred to in this disclosure and the accompanying claims as an “oxygenating agent.” It is believed that the ammonia-based pH increasing material applied according to the invention interferes with the carbon monoxide binding with hemoglobin and myoglobin in the meat product so that the oxygen may compete better with the carbon monoxide to bind with these materials. Oxygen may be used in the present treatment process to tie up hemoglobin and myoglobin in the meat thereby reducing the amount of hemoglobin and myoglobin available to react with carbon monoxide to produce the carboxy forms of the materials. Making some of the hemoglobin and myoglobin unavailable for the carbon monoxide may effectively increase the carbon monoxide saturation in a meat product that already includes some carbon monoxide saturation or decrease the amount of carbon monoxide needed to produce a desired saturation level. It is believed that the materials applied according to the present invention to interfere with the binding of carbon monoxide with hemoglobin and myoglobin in the meat product allows the present carbon monoxide treated meat product to better show spoilage in the uncooked product and to produce a more natural appearance upon cooking.

Some preferred forms of the invention may perform the pre-treatment and/or post-treatment steps in rapid succession with the carbon monoxide and ammonia-based material treatment step shown at block 103 in FIG. 1. Other preferred forms of the invention, however, may include a delay between a pre-treatment and the carbon monoxide and ammonia-based material application and/or between the carbon monoxide and ammonia-based material application and any post-treatment. The delay may be from one second to one hundred and twenty (120) seconds or more. It will be appreciated that a delay between treatment steps according to the invention may be sufficiently long to require the meat product to be moved to a holding area for at least a portion of the delay period, before proceeding on to the next application or treatment step in the process shown in FIG. 1.

FIG. 2 shows a treatment system 200 that may be used to treat meat products with carbon monoxide and an ammonia-based pH increasing material according to the present invention. System 200 includes a mixing device 201 (also referred to herein as a “mixer”) that receives carbon monoxide from a carbon monoxide supply 202 and receives a carrier liquid from a carrier liquid supply 203. A suitable carrier liquid may be water, brine, or ammonium hydroxide solution, for example, and may be pumped to mixing device 201 using a suitable pump 204 through suitable connecting line 205. The carbon monoxide is supplied preferably in the form of a gas, and thus a suitable pressure regulator 206 is provided in the connecting line 207 which connects carbon monoxide supply 202 to mixing device 201.

Treatment system 200 also includes an ammonia gas supply 210 that directs ammonia gas to mixing device through connecting line 211. A suitable pressure regulator 212 is included in line 211 to control the flow of ammonia gas to mixing device 201. Mixing device 201 receives carbon monoxide gas, ammonia gas, and the carrier liquid, water for example, and mixes the materials or allows the materials to mix to produce a suitable treatment fluid containing the desired carbon monoxide content and ammonia content. This combined treatment fluid is directed through line 215 to be applied to a highly comminuted meat product.

A sparger 218 is included in treatment system 200 to receive the treatment fluid containing carbon monoxide and ammonia through line 215 and to apply the treatment fluid to a highly comminuted meat product supplied to the sparger by a pump 219. The treatment system 200 shown in FIG. 2 also includes a grinder 222 connected to receive the treated meat product exiting sparger 218. A vacuum/flushing system 225 receives the further comminuted material exiting grinder 222 and the treated meat product is then directed to packaging system 228 where the meat product is packaged for distribution.

It will be appreciated that the diagrammatic representation of FIG. 2 does not show numerous components that may be included in system 200. For example, connecting lines 205, 207, and 211 may include numerous fittings and components such as check valves or filters. Vacuum/flushing system 225 and packaging system 228 may in fact each comprise a complicated system, the details of which are well known in the field of food processing. Details on these types of components are unnecessary for an understanding of the present invention, and thus these details are omitted from FIG. 2.

Mixer 201 may be any suitable device or combination of devices for receiving the carrier liquid, carbon monoxide, and ammonia gas and mixing the materials together to produce the desired carbon monoxide/ammonia-based material treatment fluid. For example, mixer 201 may be a sparging device or multiple sparging devices for adding the carbon monoxide gas and ammonia gas to the carrier liquid. Alternatively, mixer 201 may include one or more devices in which the carbon monoxide and ammonia-base treatment material are added to the carrier liquid through a permeable or semi-permeable membrane as the carrier liquid flows through the device or devices. In any case, where the carbon monoxide and ammonia are added to the carrier liquid separately, the ammonia is preferably applied to the carrier liquid first and then the carbon monoxide. This may help reduce the carbon monoxide gas in the resulting treatment material which may be advantageous for some implementations of the invention.

Pump 219 shown in FIG. 2 may be any suitable device for supplying sufficient driving force to drive the highly comminuted foodstuff at least through sparger 218, if not through the other devices that may be included in the system such as grinder 222, vacuum/flushing system 225, and packaging system 228. Additional pumps may be required the drive the meat product through all components of a system such as system 200 in FIG. 2. Any pump that may be required, including pump 219, may comprise a piston or other positive displacement pump, an auger-type pump, or any other type of pump.

Sparger 218 shown in FIG. 2 may comprise any suitable device for sparging the combined treatment fluid into the highly comminuted meat product supplied from pump 219. For example, the annular sparging device shown at reference numeral 15 in U.S. patent application publication No. 2003-0017252-A1 may be used to add the desired treatment fluid into the comminuted meat. Alternatively, a sparging device such as that shown at reference number 40 in U.S. patent publication No. 2003-0017252-A1, may be used to receive the carbon monoxide and ammonia-based pH increasing material mixture and apply it to the meat product. This U.S. patent application publication is incorporated herein in its entirely by this reference.

The two sparging devices at reference numerals 15 and 40 in incorporated U.S. patent application publication No. 2003-0017252-A1 are both designed to allow the comminuted meat to be treated to pass there through without significantly comminuting the meat further. However, other sparging devices that may be used as sparger 218 in the example system 200 may be adapted to be used with one or more rotating blades to further comminute the meat in connection with the sparging operation. An example of this type of sparging device is described in U.S. patent publication No. 2004-0071822-A1, which is also incorporated herein by this reference. In particular, the sparging screen 10 shown in FIGS. 1 and 2 of U.S. patent publication No. 2004-0071822-A1 may be used in connection with knifes that pass across the screen surface to cut pieces of meat that collect at the screen openings 14 in that publication.

Any sparging device that may be used to sparge the desired treatment material into the highly comminuted meat product may allow the treatment material to reach the meat product through a permeable metal or metal membrane. Both U.S. patent publication No. 2004-0071822-A1 and U.S. patent application publication No. 2003-0017252-A1 disclose permeable metal arrangements for sparging a treatment material into a meat product.

It should further be noted that although the sparger 218 is shown in FIG. 2 for applying the carbon monoxide and ammonia-based pH increasing material to the highly comminuted meat, the desired treatment material need not be applied to the meat product through a sparging device. Alternatively, the comminuted meat may be placed in a suitable vessel such as a tumbler or mixer vessel and the desired treatment material may be applied to the meat while the meat is being agitated in the vessel, or immediately before the meat is agitated.

FIG. 3 shows an alternate treatment system 300 according to the invention similar to system 200 shown in FIG. 2. Unlike the system shown in FIG. 2, however, alternate treatment system 300 applies the carbon monoxide and ammonia-based pH increasing material separately rather than as combined in a single treatment fluid. In order to apply the carbon monoxide and ammonia-based pH increasing material separately, system 300 includes a first mixer 301 which is connected to receive ammonia from an ammonia supply through a suitable pressure regulator 303, and to receive a suitable carrier fluid such as water from a carrier fluid supply 305. System 300 includes a separate second mixer 307 connected to receive carbon monoxide gas from a carbon monoxide supply 308 regulated through pressure regulator 309, and also receives carrier fluid from carrier fluid supply 305. In the particular arrangement shown in FIG. 3, carrier fluid is supplied to each mixer through a common pump 310.

System 300 also includes a pump 312 similarly to system 200 for driving the highly comminuted meat product to a sparger 314. From sparger 314, the meat product is directed to a grinder 315, a vacuum/flushing system 317, and finally a packaging system 318. Pump 312, grinder 315, vacuum/flushing system 317, and packaging system 318 may all be similar to the corresponding components in system 200 described above. However, the sparger 314 shown in system 300 comprises a multi-stage sparger to allow the carbon monoxide and ammonia-based pH increasing material to be applied separately. Multi-stage sparger 314 receives the ammonia-based pH increasing material from mixer 301 through line 321 and receives the carbon monoxide-bearing treatment material from mixer 307 through line 322. Although any multi-stage sparging device may be used for sparger 314, the multi-stage, the sparging structure shown at reference numeral 50 in U.S. patent publication No. 2004-0071822-A1 is particularly well adapted for use in connection with the separate application of carbon monoxide and ammonia-based pH increasing material to a comminuted meat product according to the present invention. It will be appreciated, however, that the single multi-stage sparger shown at 314 in system 300 may be replaced with two separate, serially connected single-stage sparging devices such as those discussed above.

Aside from the multiple sparger stages or multiple spargers required in system 300, the various components of treatment system 300 may be similar to the corresponding components shown in system 200, and are subject to the same variations. For example, each mixer 301 and 307 shown in system 300 may comprise either a sparging device or a device including a permeable or semi-permeable membrane to introduce the respective treatment material into the carrier fluid. Pump 312, grinder 315, vacuum/flushing system 317, and packaging system 318, may all be similar to the corresponding components shown in FIG. 2 and are also subject to the same variations as those corresponding components.

Numerous variations in treatment system 300 are possible within the scope of the present invention. For example, one or both of the carbon monoxide and ammonia may be applied in gaseous form, obviating the requirement for a respective mixer and a connection to receive the carrier fluid. Where a carrier fluid is used for applying both the carbon monoxide and ammonia-based pH increasing material, the carrier fluid need not be the same for both treatment materials and need not originate from the same supply. Also, the invention encompasses both the arrangement in which the ammonia-based pH increasing material is applied to the comminuted meat product first and then the carbon monoxide, and the opposite arrangement in which carbon monoxide is applied first. Particularly where carbon monoxide is applied in gaseous form, the most preferred form of the invention applies an ammonium hydroxide solution to the meat product first prior to the application of the carbon monoxide.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures (Eighth Edition, August 2001 as revised October 2005), Section 2111.03.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the following claims.

1. A method including:
(a) applying carbon monoxide to a highly comminuted meat product; and
(b) applying an ammonia-based pH increasing material to the highly comminuted meat product.

2. The method of claim 1 wherein the step of applying carbon monoxide includes applying an amount of carbon monoxide less than an amount necessary to produce complete carbon monoxide saturation in the highly comminuted meat product.

3. The method of claim 2 wherein the step of applying carbon monoxide includes applying an amount of carbon monoxide that is no more than approximately 5% to 95% of the amount necessary to produce carbon monoxide saturation in the highly comminuted meat product.

4. The method of claim 1 wherein the steps of applying carbon monoxide and ammonia-based pH increasing material are performed simultaneously.

5. The method of claim 4 wherein the ammonia-based pH increasing material comprises an ammonium hydroxide solution and the carbon monoxide is mixed with the ammonium hydroxide solution.

6. The method of claim 1 wherein the ammonia-based pH increasing material is applied prior to applying the carbon monoxide.

7. The method of claim 1 wherein the ammonia-based pH increasing material is applied after applying the carbon monoxide.

8. The method of claim 1 further including applying a carbon dioxide-based pH decreasing material to the highly comminuted meat product.

9. The method of claim 7 wherein the carbon dioxide-based pH decreasing material, carbon monoxide, and ammonia-based pH increasing material are each in gaseous form in a treatment gas mixture which is applied to the highly comminuted meat product.

10. A method including:
(a) forming a stream of highly comminuted meat product between two opposing surfaces;
(b) applying carbon monoxide to the stream of highly comminuted meat product across a first area defined by one of the opposing surfaces; and
(c) applying an ammonia-based pH increasing material to the stream of highly comminuted meat product across the first area or across another area defined by one of the opposing surfaces.

11. The method of claim 10 wherein the step of applying carbon monoxide includes applying an amount of carbon monoxide less than an amount necessary to produce complete carbon monoxide saturation in the stream of highly comminuted meat product.

12. The method of claim 11 wherein the step of applying carbon monoxide includes applying an amount of carbon monoxide that is no more than approximately 5% to 95% of the amount necessary to produce carbon monoxide saturation in the stream of highly comminuted meat product.

13. The method of claim 10 wherein the steps of applying carbon monoxide and ammonia-based pH increasing material are performed simultaneously.

14. The method of claim 13 wherein the carbon monoxide and ammonia-based pH increasing material are applied simultaneously across a common area.

15. The method of claim 10 wherein the ammonia-based pH increasing material is applied prior to applying the carbon monoxide.

16. The method of claim 10 wherein the ammonia-based pH increasing material is applied after applying the carbon monoxide.

17. The method of claim 10 further including applying a carbon dioxide-based pH decreasing material to the stream of highly comminuted meat product across the first area or across another area defined by one of the opposing surfaces.

18. The method of claim 17 wherein the carbon dioxide-based pH decreasing material, carbon monoxide, and ammonia-based pH increasing material are each in gaseous form in a treatment gas mixture which is applied to the stream of highly comminuted meat product.

19. The method of claim 10 wherein the stream of highly comminuted meat product has a cross-sectional dimension similar to a cross-sectional dimension of individual pieces of meat product making up the highly comminuted meat product.

20. A method including:
(a) forcing a mass of highly comminuted meat product through a conduit;
(b) applying carbon monoxide to the highly comminuted meat product in at least a portion of the conduit; and
(c) applying an ammonia-based pH increasing material to the highly comminuted meat product in at least a portion of the conduit.

21. The method of claim 20 wherein the carbon monoxide and ammonia-based pH increasing material are applied simultaneously across a common portion of the conduit.

22. The method of claim 20 wherein the highly comminuted meat product is forced through the conduit in a process direction and wherein the ammonia-based pH increasing material is applied ahead of the carbon monoxide in the process direction.

23. The method of claim 20 wherein the highly comminuted meat product is forced through the conduit in a process direction and wherein the ammonia-based pH increasing material is applied after the carbon monoxide in the process direction.
